(19) United States
(12) Patent Application Publication
(10) Pub. No.: US 2010/0025969 A1
(43) Pub. Date: Feb. 4, 2010

(54) Adjustable Wheelchair

(76) Inventors: Rich Kent, Portland, OR (US); Wayne Summers, Seattle, WA (US)

Correspondence Address: APEX JURIS, PLLC, 12733 LAKE CITY WAY NORTHEAST, SEATTLE, WA, 98125, US

(21) Appl. No.: 12/357,111

(22) Filed: Jan. 21, 2009

Related U.S. Application Data
(60) Provisional application No. 61/022,328, filed on Jan. 19, 2008.

(51) Int. Cl. A61G 5/08

(52) U.S. Cl. 280/647

(57) ABSTRACT

An adjustable wheelchair frame that has a pair of rear wheels, a pair of front wheels, a pair of handles, and the wheelchair frame where said wheelchair frame has a first base adjustment section, a second base adjustment section, a first height adjustment section, a second height adjustment section, and where the first base adjustment section is adjustably and lockably connectable to the first height adjustment section and the second base adjustment section is adjustably and lockably connectable to the second height adjustment section; the first base section is adjustably and lockably connectable to said second base adjustment section and the first height adjustment section is adjustably and lockably connectable to said second height adjustment section, thus providing a wheelchair that is entirely adjustable for width and floor to seat height.

### 1. FIELD OF THE INVENTION

The present invention claims priority to U.S. Provisional Patent Application Ser. No. 61/022,328 filed on Jan. 19, 2008. The present invention is in the art of wheelchair construction having a frame, seat, back rest, wheels, arms and foot rest assemblies adjustably connected together. Main wheels with quick release and caster wheels connected to the frame support the wheelchair on a floor or similar surface.

### 2. BACKGROUND OF THE INVENTION

There are many types of wheelchairs and they have long been developed so as to be increasingly usable and readily operable for the user sitting in the wheelchair. In general, wheelchairs have most or all of the following sections: a seat on which the user sits, a back rest in connection with the seat, handles in connection with the back rest for use by others to assist the user to move the wheelchair, foot rests if needed, wheels and a chassis or a frame which supports the previously mentioned sections.

There have been many variations to the standard wheelchair including many mechanical and electronic varieties. However, the basic design has remained relatively unchanged. Conventional wheelchairs have metal frames of tubular members secured together with welds to specific sizes. The parts of these welded chairs are not adjustable to allow for different wheelchair sizes and dimensions and thus, separate frames must be constructed for each different wheelchair size. As a result, companies that sell wheelchairs must keep a constant stock of different sized wheelchairs. This is inefficient because many sizes are required, this takes up storage space and is expensive for the sellers and for the manufacturers. Additionally, having one, entirely adjustable wheelchair prevents waste and is therefore more environmentally friendly.

### SUMMARY OF THE INVENTION

The object of the present invention is to realize an adjustable wheelchair where the frame is separately adjustable without additional alteration of other parts. The wheelchair of the present invention has lockably and releasably connectable parts that allow for easy and convenient part replacement and wheelchair frame width and floor to seat height adjustment.

The object forming the basis of the present invention will be attained if the wheelchair intimated by way of introduction is characterized in that the frame comprises a first section that is easily horizontally adjustable by using slideably, connectable tubing, or arms. The size or shape of the seating connected to the arms is also simply adjustable, for example, by using Velcro or some other similarly adjustable material. The adjustable seating material also could use an elastic strap with a locking mechanism to maintain tension as a securing means. Large rear wheels using quick release mechanisms are connected to the rear of the tubular frame. Smaller front caster wheels are attached to the front support to allow the chair to easily turn. Foot rest assemblies are also quickly attachable to the front portion to accommodate the legs and feet of the person seated on the wheelchair. The floor to seat height is adjustable using a mechanism similar to the horizontal adjustment mechanism in addition to the use of different sized wheels. Next, the back section of the chair is also attachable and vertically adjustable, again using the same type mechanism used for the horizontal adjustability. Velcro or some other similarly adjustable material is also used for the seat backing. A padding or other material can also be added to the seat and back for additional comfort. Finally, the handles can be fixed or adjustable to a specified length.

### BRIEF DESCRIPTION OF THE DRAWINGS

The present invention will now be described in greater detail hereinbelow with reference to the accompanying Drawings. In the accompanying Drawings:

FIG. 1 is a perspective view of a wheelchair of the invention;

FIG. 2 is a side elevational view of the main frame portion of the wheelchair of FIG. 1;

FIG. 3 is an exploded perspective view of the seat frame assembly of the wheelchair of FIG. 1;

FIG. 4 is a perspective view of the frame assembly of the wheelchair of FIG. 1 showing the height adjustment sections assembled and an exploded view of the width adjustment sections of the wheelchair of FIG. 1;

FIG. 5 is a side elevational view of the wheelchair of FIG. 1 showing complete frame assembly and connection of the four main sections and further showing appropriate pin placement;

FIG. 6 is a perspective, partially exploded view of the height adjustment sections of the frame of FIG. 5;

FIG. 7 is a side elevational view showing back assembly;

FIG. 8 is an end elevational view showing how the back section is assembled;

FIG. 9 is an end elevational view showing the back section after complete assembly

### DETAILED DESCRIPTION OF THE INVENTION

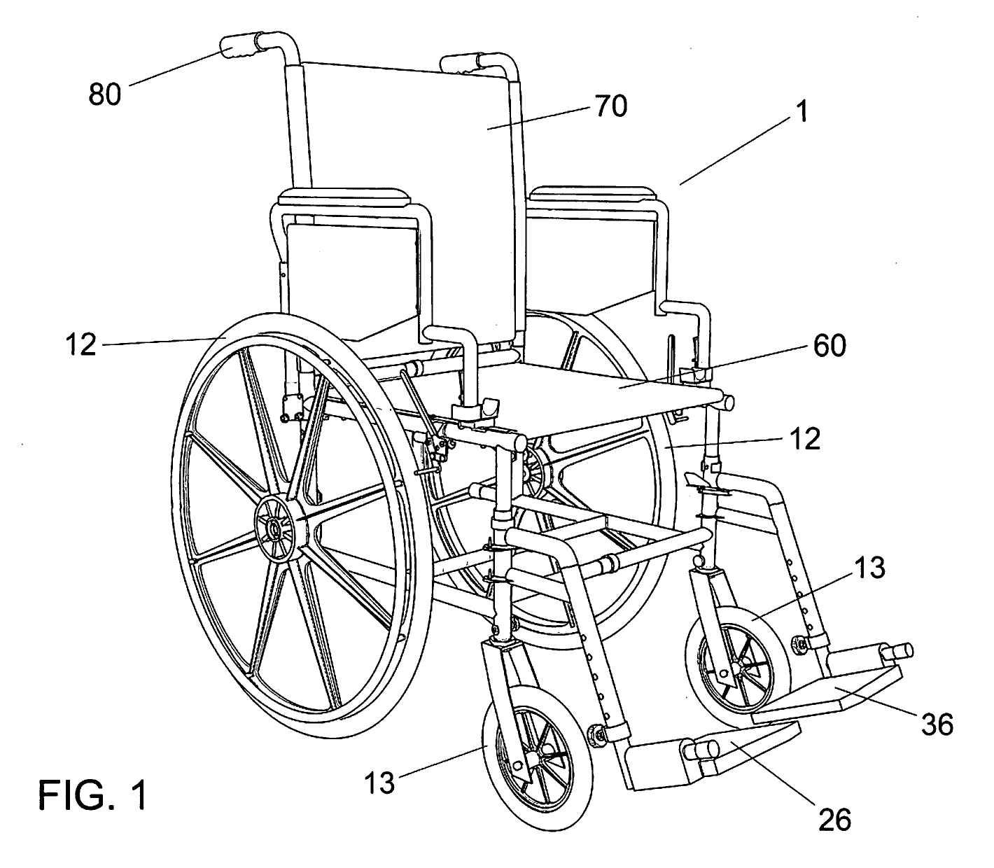

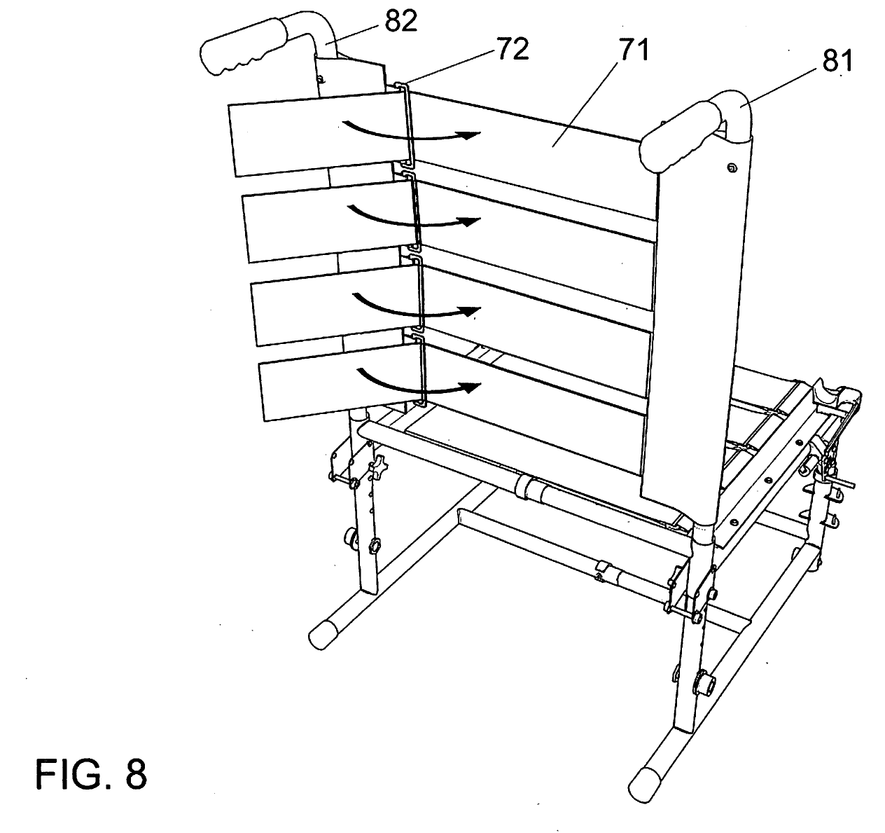

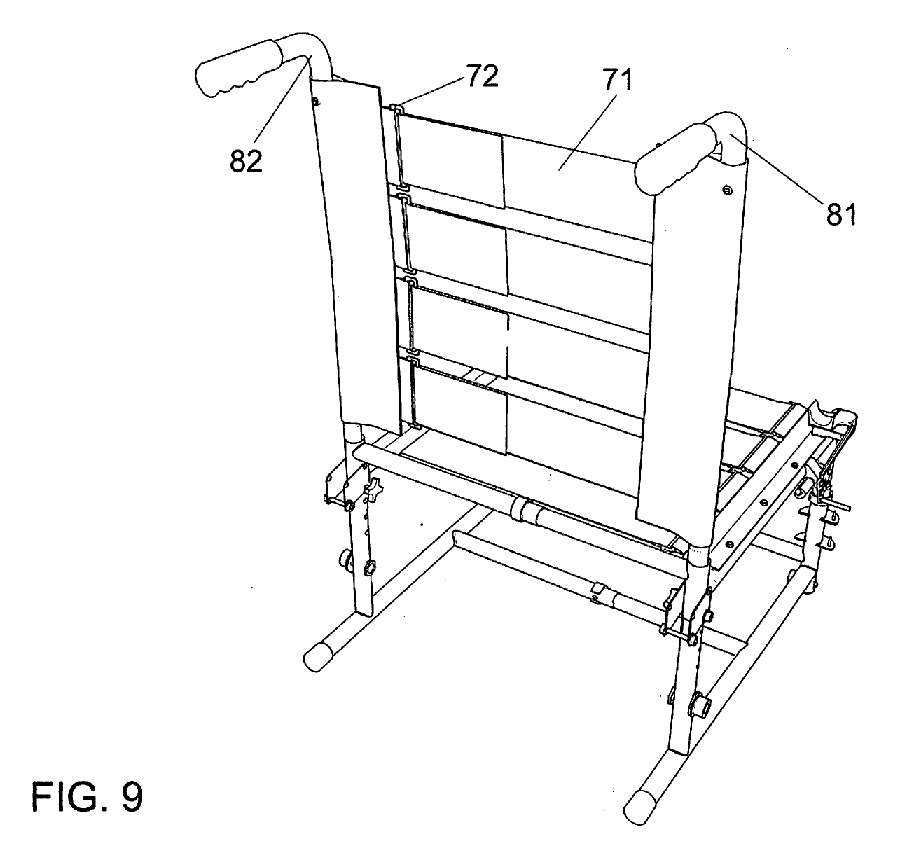

Referring now to the drawings, wherein like reference numerals designate identical or corresponding parts throughout the several views, the present invention will be described with reference to FIGS. 1-9.

FIG. 1 is a perspective view of the first embodiment of the wheelchair of the present invention. A wheelchair 1, shown in FIG. 1, has a seat 60 and a back rest 70. Further, the wheelchair has two pairs of wheels 12, 13. The wheels 12, 13 are pairwise of different sizes. The larger wheels 12 are placed largely straight beneath the back rest 70 but behind the point of gravity of the wheelchair 1 in order to prevent the wheelchair 1 from spontaneously tipping backwards. These wheels are typically large enough to allow for the user to push them and to propel the chair. Additionally these wheels can be equipped with quick release mechanisms to allow for easy removal and attachment and come in a variety of sizes to facilitate additional floor to seat adjustment. The front wheels are typically smaller and are rotatable to allow for steering and are also easily attached and removed from the main frame.

In conjunction with or in the proximity of the back rest 70 there are disposed a pair of handles 80 that are intended to be held by someone other than the user for propelling the wheelchair 1. These are either fixed or adjustable and may come in a variety of sizes. Further, the wheelchair is provided with an optional pair of foot rests 26, 36.

All the wheels 12, 13, the seat 60, the back rest 70 and foot rests 26, 36 are supported by a frame 10. The completely assembled frame 10 is cubic in design and is comprised of four parts; a first left side base section 20, a second right side base section 30, a first left side height adjustment section 40, and a second right side height adjustment section 50.

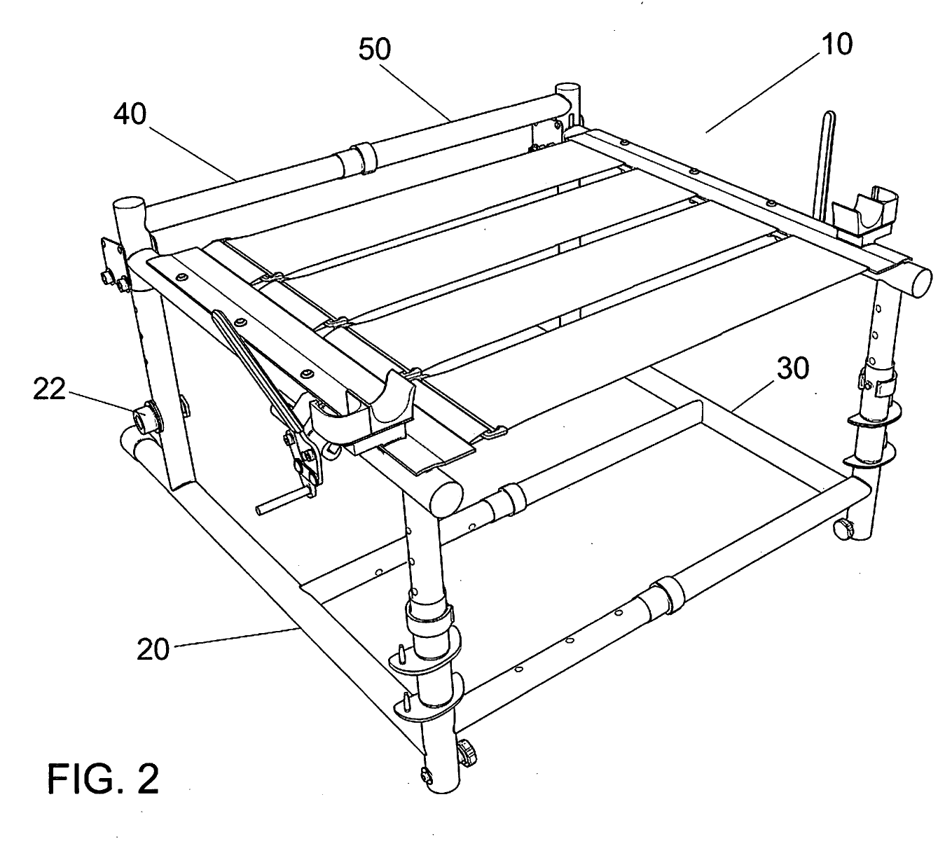

FIG. 2 is a perspective view of the main wheelchair frame parts; the first left side base section 20, the second right base section 30, the first left side height adjustment section 40 and the second right side height adjustment section 50 as completely assembled. Left side 20 and right side 30 base sections comprise the bottom two sections of the four adjustable sections of the wheelchair. Left side 20 and right side 30 base sections are almost U shaped outer sections. These outer sections are used for attaching the quick release rear wheels to sections 20, 30 on both sides at the quick disconnects 22, 32 respectively, front wheels 13 and foot rests 26, 36 to the front of the chair, as seen in FIG. 1. Additionally, they are used as base unit for and in conjunction with sections 40 and 50 for width adjustment. This tubing is typically hollow metal tubing but may be made of any material that has characteristics suitable for usage.

It should be noted for clarification purposes that throughout the description the terms “left” and “right” refer to the wheelchair when it is being looked at from the front. Correspondingly, the term “front” refers to the section in the front of the wheelchair when looking at the seat and the portion where the footrests are attached. The term “rear” refers to the section that includes the section where the handles are attached.

Although the wheelchair is described herein for adult sizing, it should be noted that the wheelchair is not restricted to adult usage. That is, the chair may be sized for pediatric usage and is configurable to almost any size. Thus, in order for varying sized individuals to utilize the chair it is important to have an adjustable seat, both widthwise and heightwise. Widthwise adjustment is described first.

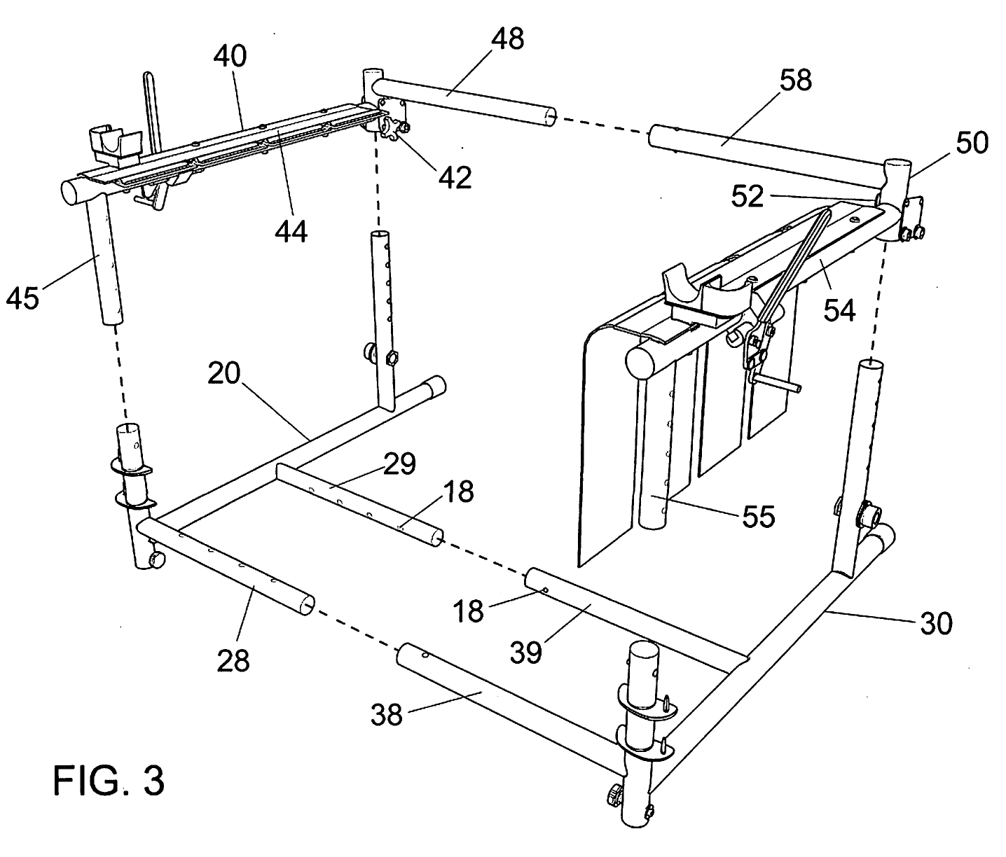

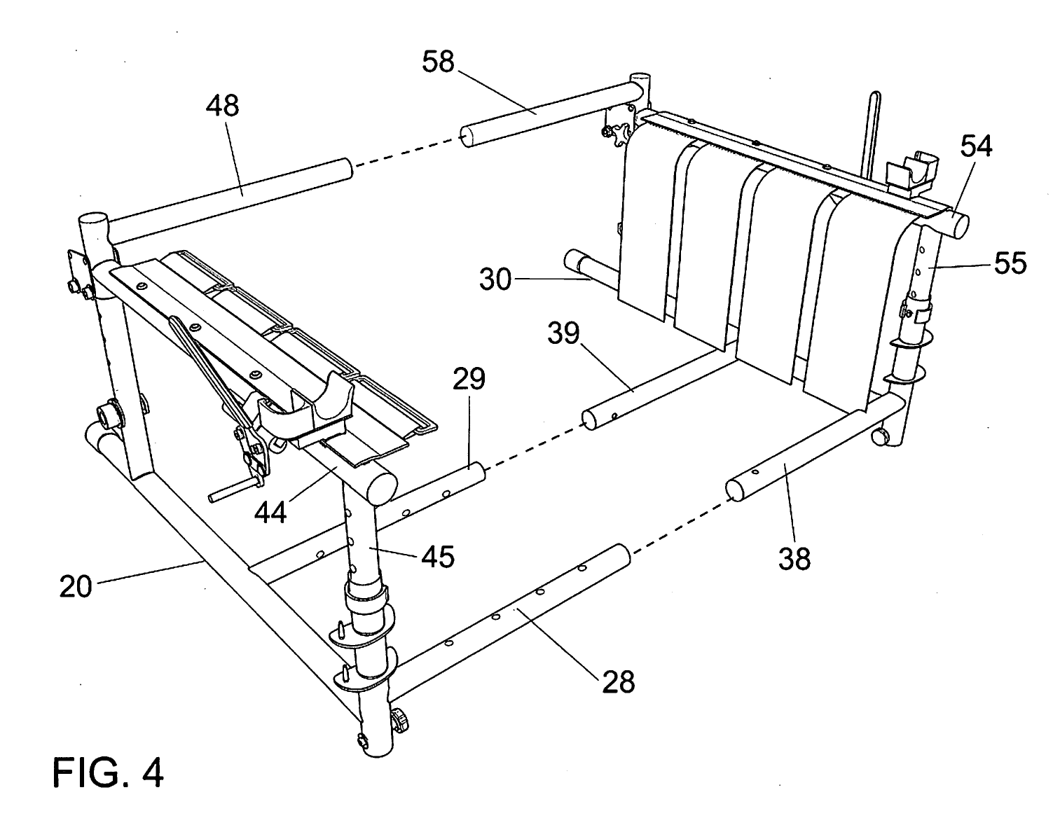

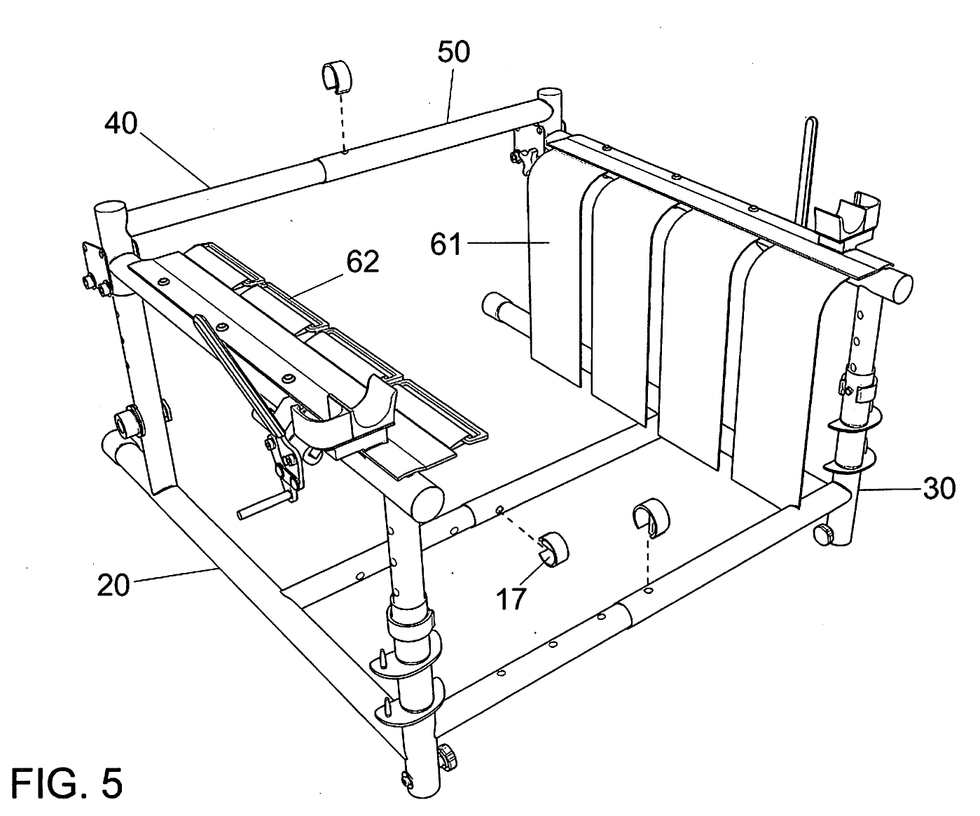

FIGS. 3 and 4 show perspective views illustrating the horizontal adjustment of the four parts. When the wheelchair is upright the two left and two right side outer tubes of sections 20 and 30, attached to the front and back of sections 20 and 30 respectively, are perpendicular to the ground. Extending horizontally from the lower portion of both U shaped sides 20 and 30 are front tubes 28, 38 and intermediary tubes 29, 39 that slide together to adjust the seat width. In order for the width adjustments to be made, left side base section 20, right side base section 30, left side height adjustment section 40 and right side height section 50 all must be incorporated. As described above, sections 20 and 30 have almost U shaped outer sections and two additional horizontal tubes and thus form the lower portion of the chair. Left and right side height adjustment sections 40, 50 are also made from tubes or arms and include first horizontal adjustment arms 48, 58; main arms 44, 54; front vertical adjustment arms 45, 55; and the locking knob components 42, 52. The main arms 44, 54 can also be used for attachment and placement of arm rests and braking mechanisms, as shown in FIGS. 1 and 5.

Although typically made of hollow metal tubing the tubing could also be made of any available, structurally sound material that provides the same functions as described herein. For this embodiment, the front tubing 38, intermediary tubing 39 and rear tubing 58 are slightly larger in diameter than corresponding front tubing 28, intermediary tubing 29 and rear tubing 48 so that second corresponding tubing 28, 29 and 48 can easily be inserted into tubing 38, 39 and 58, thereby allowing tubing 28, 29 and 48 to easily slide in and out of front, intermediary and rear tubing, thus providing a wide range of horizontal adjustability.

All sets of horizontal tubing have matching holes 18 drilled therethrough. Generally these holes 18 are drilled dimensionally to allow for lockedly setting the horizontal width to 16, 18 or 20 inches. These are the standard dimensions for K4 wheelchairs presently in the market. Although these are the most common sizes it should be noted that the chair is not restricted to these limitations. Any length tubing could be utilized to provide for a chair of any dimension, including those usable for excessively large chairs or alternatively for smaller chairs, as for use in pediatrics.

As shown in FIG. 5, in order to lock and secure the width at the selected dimension snap ring connectors/locking pins 17 are provided. The mating tubes are slid together, the holes are aligned at a chosen dimension and the pins are inserted through the appropriate holes, thereby locking the horizontal width in place. The pins can be any variety, including the common “push pin” mechanism locking pin; a separate locking pin; snap ring with locking pin or any variety of locking mechanism that will secure the tubes in place.

After the tubing is set to the desired dimension the seating area 60 is adjusted. The seating is made of adjustable seat straps 61. In the embodiments shown there are four straps. However, the number of straps can be more or less depending on the width of the material used and depending on the size of the chair. The straps are secured to side base sections 20 and 30 with Velcro or some other adjustable material. The straps may also be permanently attached to side base sections 20 and 30. Next, the straps meet in the middle section between section sides 20 and 30 and are then connected in the middle, again using Velcro or the like. Alternatively, the straps could be securely and permanently attached to just one side and the opposite side could have buckles 62. In this embodiment the straps 61 are passed through the buckles 62 and are then returned to the center for easy adjustment. Again, the center of the belt utilizes Velcro or some other mechanism to securely attach the strap to itself. This allows for a wide array of adjustability and does not limit the chair dimensions. Additionally, padding may be added over the straps for comfort.

Finally, the horizontal tubing has another set of holes 18 that correspond to each other when the tubing is slid completely together. When the user wants to transport the chair the side base sections 20 and 30 and height adjustment sections 40, 50 are slid entirely together using tubes 28, 38, 29, 39, and 48, 58 until they cannot be pushed any further together. When completely together there are a set of matching holes 18 and the aforementioned and described pins 17 are inserted through the holes thereby locking the horizontal width to its smallest dimension in place for transportation.

Additionally, in order to facilitate transportability, the large rear wheels 12 utilize quick release mechanisms 22, 32 that facilitate easy removal and as earlier noted, can be of varying sizes. As can be seen in FIG. 1, the large wheels are attached to the lower portion of the U-shaped side base sections 20 and 30 and quick disconnect sections 22, 32. These are typically standard type quick release sections that utilize a “push pin” axel that is inserted through lower holes in the rear portion of the U-shaped side bases.

The removable front wheel also uses a locking pin mechanism. The smaller diameter tubing of the front wheels are inserted into the larger diameter vertical tubing located at the front of the left and right side base sections. There is a hole drilled through the tubing of the front wheel. This hole is aligned with a corresponding hole located towards the bottom of the vertical tubing at the front of the left and right side base sections. Once the holes are aligned, a single threaded bolt is inserted into the holes from the inside of the frame and then it is threaded into a separate locking nut on the outer side of the frame.

Finally, the push handles 80, front wheels 13, and foot rests 26, 36 are easily removed for convenient transportation. These parts can all be removed quickly and simply from the chair. After these parts are removed the chair can be pushed together to lock into the smallest dimension using the placement holes and locking pins. Because all parts are effortlessly removed and because the chair compresses to a relatively small size it is readily transportable.

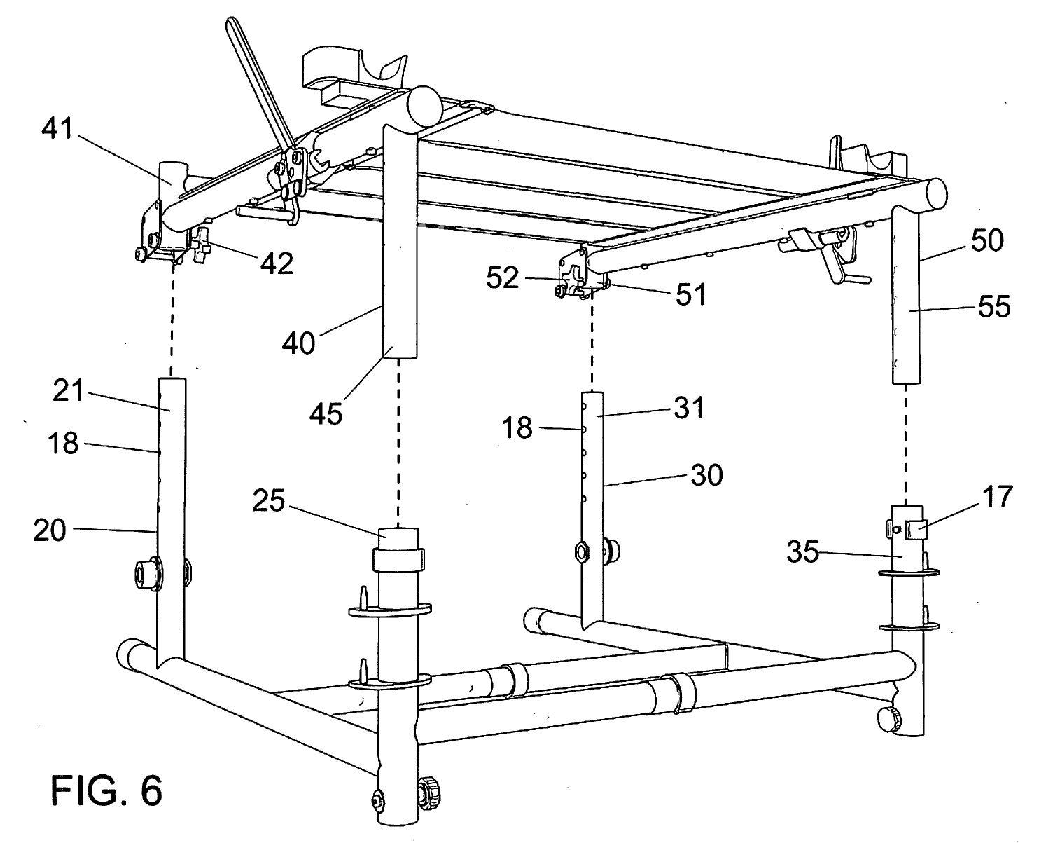

FIG. 6 shows a perspective view illustrating the vertical assembly of four parts. As noted above, floor to seat height adjustment is also important and is described next. Floor to seat height adjustment sections are similar to the above described width adjustment sections. The same or similar hollow tubing or arms used for the width adjustment are used for the floor to seat height adjustment. The frame 10 contains two height adjustment sections, specifically left side height adjustment section 40 and right side height adjustment section 50. The height adjustment sections 40 and 50 mate with the U-shaped side base sections 20 and 30 at the base front vertical tubing 25, 35 and at the rear via left and right side locking knob components 42 and 52. The left and right front side vertical adjustment arms 45, 55 have a narrower diameter and are inserted into corresponding vertical base section tubing 25, 35 with larger diameter. Thereafter the holes are aligned at the desired height and pins 17 are inserted through mating holes to secure the position thus allowing easy insertion of corresponding tubing for adjustability.

Next, as shown in FIG. 6, the rear section is mated by inserting rear vertical arms 21, 31 into left and right side height adjustment sections 41, 51. These sections 41, 51 further comprise locking knob mechanisms 42, 52. The locking knob mechanism performs basically the same function as locking pins 17. However, the mechanism has a more solid, threaded bolt type connector that is screwed into a mating component in order to provide more stability to the chair. All sets of vertical tubing have matching holes 18 drilled therethrough. Generally these holes are drilled dimensionally to allow for setting the vertical floor to seat height adjustment at 16, 18 or 20 inches. These are the standard dimensions for K4 wheelchairs presently in the market. Although these are the most common sizes it should be noted that the chair is not restricted to these limitations. Any size tubing could be utilized to provide for a chair of any dimension. In order to secure the floor to seat height at a set dimension snap ring connection/locking pins 17 are provided in the front and the locking knob is preferably provided in the rear. The tubes are slid together, the holes 18 are aligned at a chosen dimension and the pins 17 are inserted through the appropriate holes 18 thereby locking the vertical floor to seat height in place. The pins can be any variety, including the common “push pin” mechanism locking pin; a separate locking pin; snap ring with locking pin or any variety of locking mechanism that will secure the tubes in place.

Finally, the vertical tubing has another set of holes that correspond to each other when the tubing is slid completely together. When the user wants to transport the chair the base sections 20 and 30 and height adjustment sections 40 and 50 are slid entirely together using tubes until they cannot be pushed any further together. When completely together there are a set of matching holes and the aforementioned and described pins 17 are inserted through the holes thereby locking the horizontal width and vertical height to their smallest dimensions in place for transportation.

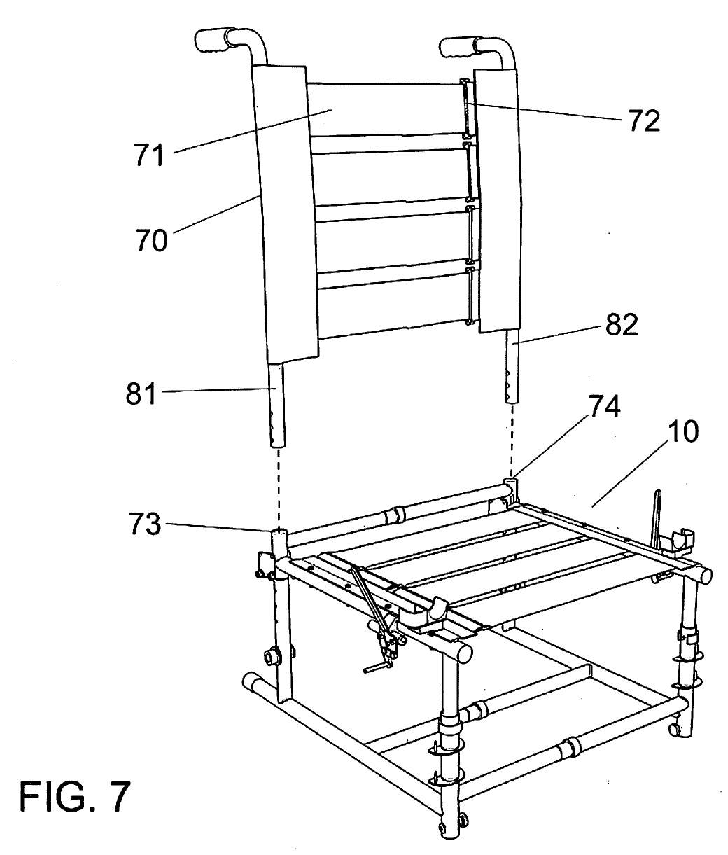

As shown in FIGS. 7, 8 and 9, for maximum adaptation to different users, the back rest 70 is separately attachable in relation to the seat and will be described next. It should be noted that the detailed description for the back assembly is similar to that for the seat assembly; however, the figures included are slightly more comprehensive for the back assembly. The back rest 70 uses either a simple, fixed back canes 81, 82 or an adjustable back cane. The back rest 70 may utilize the same basic adjustment mechanism used in the floor to seat height and width adjustment. The base frame 10 has back rest insertion holes 73, 74 for inserting back rest canes 81, 82. The back rest canes can be attached using a system as described above with different sized tubing and either mounting screws and lock nuts or they can be mounted using a system as described above where canes 81, 82 are slid into insertion tubes 73, 74 and are then either fixed using locking pins or the above described mounting screws and lock nuts. After the tubing is set to the desired dimension the seat backing area is adjusted. In the preferred embodiment the seating is made of adjustable straps 71. In the embodiments as shown in FIG. 7, there are four straps 71. However, the number of straps could be more or less depending on the width of the material used. The straps are secured to back canes 81, 82 with Velcro or some other adjustable material. The straps may also be permanently attached to back canes 81, 82. Next, the straps meet in the middle section between back canes 81, 82 and are then connected in the middle, again using Velcro or the like. Alternatively, the straps could be securely attached to just one side and the opposite side could have buckles 72. The straps 71 are passed through the buckles 72 and are then returned to the center for easy tightening. The center of the belt utilizes Velcro or some other mechanism to securely attach the strap to itself. This allows for a wide array of adjustability and does not limit the chair dimensions. Additionally, padding may be added over the straps to provide more comfort.

In many cases, the user may need foot rests 26, 36. These are disposed on the same part of the frame 10 as the small wheels 13, that is, on the left and right side base sections 20, 30 as seen in FIG. 1. Moreover, they are adjustable, for example may be angled, for adaptation to the user of the wheelchair 10, partly in respect of the user's body size and partly in respect of the user's method of using the wheelchair 10. Further, the foot rests 26, 36 are raisable and lowerable if the need for them is only temporary. As noted above, the foot rests may also be wholly dismounted if the user has no need for them at all. Naturally, it is also possible to dismount only one of the foot rests 26, 36. Regardless of how the foot rests are adapted, their adjustment will remain unchanged on raising and lowering of the seat and regardless of any other adjustments.

It should be noted that the armrests and rear wheels shown are common in the industry and are in no way unique to this invention. While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, the wheelchair can be of any dimension or size to accommodate children or adults of any size, the tubing could be cylindrical, square, or any other shape, the connector pins can be any variety of connector that will provide a secure connection, and the wheels can be of any variety. Therefore, the invention, in its broader aspects, is not limited to the specific details, the representative apparatus, and illustrative examples shown and described. Accordingly, departures can be made from such details without departing from the spirit or scope of the applicant's general inventive concept.

### Part Listing

1. Wheelchair
10. frame
12. rear wheels
13. front wheels
14. arm rest connector
15. brake
16. footrests
17. locking pins/rings
18. holes
19. locking knob
20. left side base section
21. left side base rear vertical arm
22. left side base quick disconnect
23. left side base rear extension
24. left side base outside horizontal arm
25. left side base front vertical arm collar
26. footrest
27. left side base front wheel connector
28. left side base front horizontal adjustment arm
29. left side base intermediate adjustment arm
30. right side base sections
31. right side base rear vertical arm
32. right side base quick disconnect
33. right side base rear extension
34. right side base outside horizontal arm
35. right side base front vertical arm collar
36. footrest
37. right side base front wheel connector
38. right side base front horizontal adjustment arm
39. right side base intermediate adjustment arm
40. left side height adjustment section
41. left side rear height adjustment section
42. left side locking knob mechanism
43. left side horizontal adjustment arm
44. left side main arm
45. left side front vertical adjustment arm
50. right side height adjustment section
51. right side rear height adjustment section
52. right side locking knob mechanism
53. right side horizontal adjustment arm
54. right side main arm
55. right side front vertical adjustment arm
60. seat
61. seat straps
62. seat strap buckle
70. back rest
71. back straps
72. back strap buckle
80. handles
81. left side back rest canes
82. right side back rest canes

1. An adjustable wheelchair frame including a pair of rear wheels, a pair of front wheels, a pair of handles, and the wheelchair frame where said wheelchair frame comprises:
a first base adjustment section;
a second base adjustment section;
a first height adjustment section;
a second height adjustment section;
said first base adjustment section is adjustably and lockably connectable to said first height adjustment section and said second base adjustment section is adjustably and lockably connectable to said second height adjustment section;
said first base section is adjustably and lockably connectable to said second base adjustment section;
said first height adjustment section is adjustably and lockably connectable to said second height adjustment section.

2. The adjustable wheelchair frame of claim 1 further comprising an adjustable seating material connectable to said frame.

3. The adjustable wheelchair frame of claim 1 further comprising a seat back where said seat back has an adjustable back material connectable to said frame.

4. The adjustable wheelchair frame of claim 1 where at least one rear height adjustment section uses a locking knob.

5. The adjustable wheelchair frame of claim 1 where the lockably connectable mechanism is a locking pin.

6. The adjustable wheelchair frame of claim 1 where the lockably connectable mechanism is a push-pin.

7. The adjustable wheelchair frame of claim 1 where the lockably connectable mechanism is a twist lock.

8. The adjustable wheelchair frame of claim 1 where the lockably connectable mechanism is a pull pin with a quick release mechanism.

9. The adjustable wheelchair frame of claim 1 where the rear wheels are connected using a quick release mechanism.

10. The adjustable wheelchair frame of claim 1 where the front wheels are connected using a quick release mechanism.

11. The adjustable wheelchair frame of claim 10 where the front wheels are connected using a threaded lock knob.

12. The adjustable wheelchair frame of claim 1 with at least one braking mechanism.

13. The adjustable wheelchair frame of claim 2 where said adjustable seating material uses Velcro as a securing means.

14. The adjustable wheelchair frame of claim 2 where a first section of said seating material is permanently connected to one side of said frame and where at least one seat strap buckle is securely connected to another side of said frame and where said first section of said seating material is drawn through said buckle and returned to meet and overlap itself thereby securing the seating material at a chosen dimension.

15. The adjustable wheelchair frame of claim 3 where a first section of said back material is permanently connected to one side of said frame and where at least one back strap buckle is securely connected to another side of said frame and where said first section of said backing material is drawn through said buckle and returned to meet and overlap itself thereby securing the backing material at a chosen dimension.

16. The adjustable wheelchair frame of clam 2 where said adjustable seating material uses an elastic strap with a locking mechanism to maintain tension as a securing means.

17. The adjustable wheelchair frame of claim 16 where a first section of said seating material is permanently connected to one side of said frame and where at least one seat strap buckle is securely connected to another side of said frame and where said first section of said seating material is drawn through said buckle and returned to be securely attached to a locking mechanism on the original side of said frame thereby securing the seating material at a chosen dimension.

18. The adjustable wheelchair frame of claim 16 where a first section of said back material is permanently connected to one side of said frame and where at least one back strap buckle is securely connected to another side of said frame and where said first section of said backing material is drawn through said buckle and returned to be securely attached to a locking mechanism on the original side of said frame thereby securing the backing material at a chosen dimension.

19. The adjustable wheelchair frame of claim 1 where said handles are adjustable lengthwise.
